(19) United States
(12) Patent Application Publication
(10) Pub. No.: US 2011/0290914 A1
(43) Pub. Date: Dec. 1, 2011

(54) HVLP TOOLBOX SPRAYER

(76) Inventors: Diane L. Olson, Princeton, MN (US); Michael D. Vangstad, Zimmerman, MN (US); Craig J. Wojclachowski, Foley, MN (US); Keith A. Christensen, Coon Rapids, MN (US)

(21) Appl. No.: 13/140,183

(22) PCT Filed: Dec. 14, 2009
(86) PCT No.: PCT/US09/67901

§ 371 Date: Jun. 16, 2011

(51) Int. Cl. B05B 7/02

(52) U.S. Cl. 239/526

(57) ABSTRACT

An HVLP spray system and toolbox design offers a fully integrated system that is durable on the jobsite, has internal storage for all basic tools needed to do the job and offers integrated user features specific to the application.

### TECHNICAL FIELD

This application claims the benefit of U.S. Application Ser. No. 61/138,576, filed Dec. 18, 2009, the contents of which are hereby incorporated by reference.

1. Background Art

Current HVLP spray systems are easily damaged and have few integrated user features.

2. Disclosure of the Invention

It is an object of this invention to integrate an HVLP spray system into a toolbox design to offer a fully integrated system that is durable on the jobsite, has internal storage for all basic tools needed to do the job and offers integrated user features specific to the application.

The design is comprised of two molded sections, a base and a lid. The turbine motor is housed in the center of the package, well protected from external bumps and drops. To the left and right of the turbine motor are cavities utilized for internal storage of the HVLP cup gun, as well as extra needle/nozzle sets, rags, and other items needed on the job. The lid will be molded to include various storage compartments for small items, a tape holder, and an external gun resting position for setting the gun down while on the job.

The design can be laid out to either encompass a hinged lid configuration with front clasps or a removable lid configuration with side locking clamps. Further, the design can be configured such that the air hose for the spray system can be stored internal to the base or in the underside of the lid.

Finally, the design will be configured to accept a modular, optional air compressor to be installed to the side of the turbine motor. This configuration supports a remote cup.

The proposed design is better suited for the jobsite environment by standing up to rough handling and riding in the back of trucks. Further, the user will not struggle to keep track of all the items needed to accomplish the job, as they will all be stored in one integrated package. If the user chooses to upgrade to the benefits of a remote cup option, they simply purchase and plug in the modular compressor, versus today buying a dedicated turbine/compressor unit or a separate, free-standing compressor unit that must sit beside the turbine unit.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 is a front view of the sprayer of the instant invention.

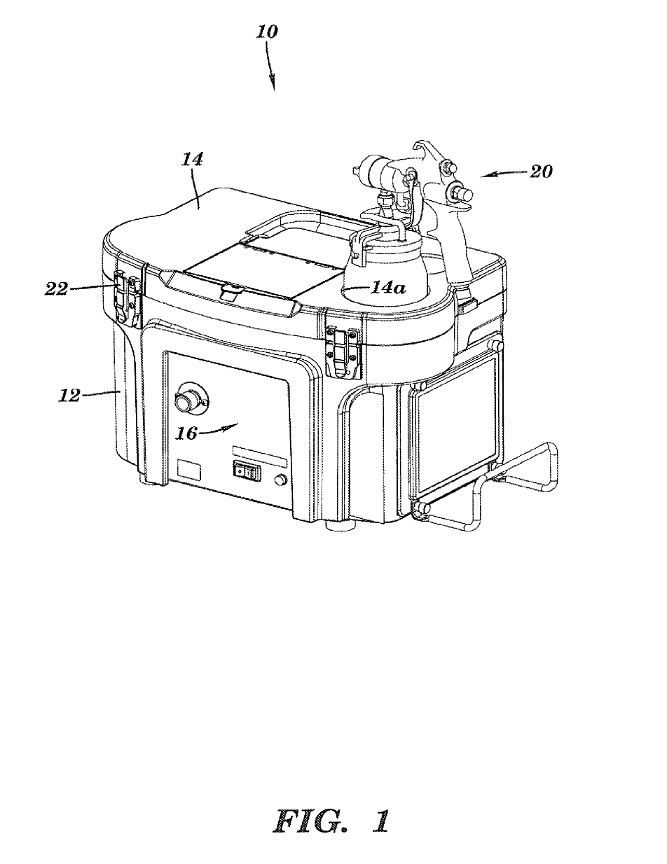

FIG. 2 is a rear view of the sprayer of the instant invention.

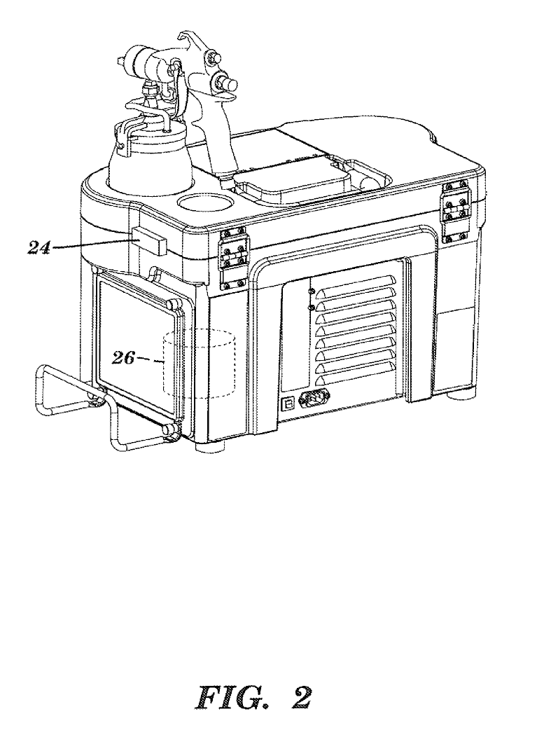

FIG. 3 is a front view of the sprayer of the instant invention with the lid opened.

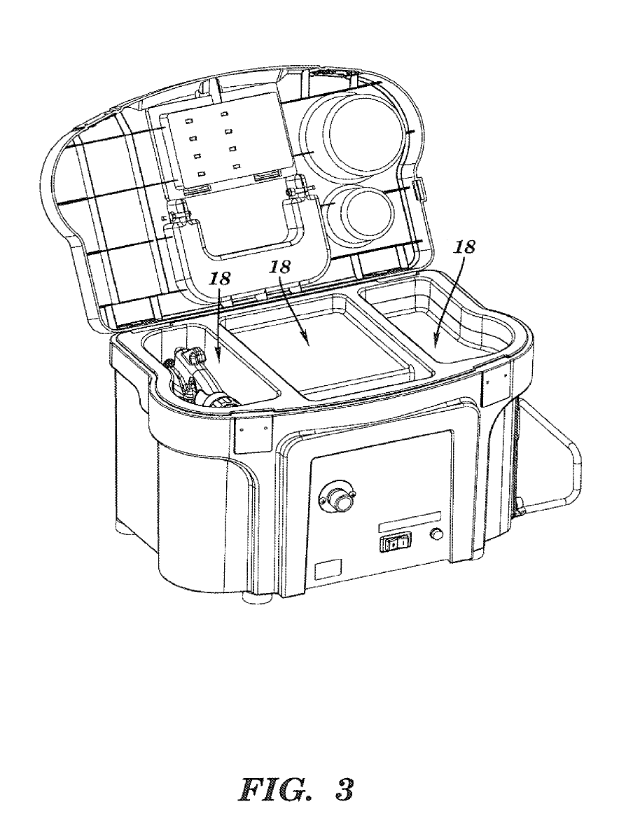

### BEST MODE FOR CARRYING OUT THE INVENTION

The sprayer 10 is comprised of two molded sections, a base 12 and a lid 14. The turbine motor 16 is housed in the center of the package, well protected from external bumps and drops. To the left and right of the turbine motor 16 are cavities 18 utilized for internal storage of the HVLP cup gun 20, as well as extra needle/nozzle sets, rags, and other items needed on the job. The lid 14 will be molded to include various storage compartments for small items, a tape holder, and an external gun resting position 14a for setting the gun down while on the job.

The design can be laid out to either encompass a hinged lid 14 configuration with front clasps 22 or a removable lid configuration with side locking clamps 24. Further, the design can be configured such that the air hose for the spray system can be stored internal to the base or in the underside of the lid.

Finally, the design can be configured to accept a modular, optional air compressor 26 to be installed to the side of the turbine motor 16. This configuration supports a remote cup.

It is contemplated that various changes and modifications may be made to the sprayer, without departing from the spirit and scope of the invention as defined by the following claims.

1. An HVLP sprayer for use with a spray gun and an air hose and comprising:
a base having first and second ends;
a lid having an underside;
a turbine motor housed said base; and
at least one cavity in said base for storage of said spray gun and other parts and accessories.

2. The sprayer of claim 1 wherein said turbine motor is located in the center of said base.

3. The sprayer of claim 1 wherein said lid is molded to include various storage compartments and an external gun resting position for setting the gun down while on the job.

4. The sprayer of claim 1 wherein said lid is hinged to said base.

5. The sprayer of claim 1 wherein said lid is clamped to said base.

6. The sprayer of claim 1 wherein said air hose can be stored in said base.

7. The sprayer of claim 1 wherein said air hose can be stored in the underside of said lid.

8. The sprayer of claim 1 further comprising a modular air compressor to be installed to the side of the turbine motor.
